(19) United States
(12) Patent Application Publication
(10) Pub. No.: US 2024/0348056 A1
(43) Pub. Date: Oct. 17, 2024

(54) CHARGING AND DISCHARGING MANAGEMENT SYSTEM AND VEHICLE

(71) Applicant: TOYOTA JIDOSHA KABUSHIKI KAISHA, Toyota-shi (JP)

(72) Inventors: Shunsuke KOBUNA, Mishima-shi (JP); Masato EHARA, Gotemba-shi (JP); Tomoya TAKAHASHI, Ebina-shi (JP)

(73) Assignee: TOYOTA JIDOSHA KABUSHIKI KAISHA, Toyota-shi (JP)

(21) Appl. No.: 18/421,393

(22) Filed: Jan. 24, 2024

(30) Foreign Application Priority Data
Apr. 13, 2023 (JP) 2023-065805

(51) Int. Cl. H02J 3/32; B60L 53/62; B60L 53/63; B60L 55/00; B60L 58/16

(52) U.S. Cl. CPC H02J 3/322; B60L 53/62; B60L 53/63; B60L 55/00; B60L 58/16

(57) ABSTRACT

A charging and discharging device that manages the charging and discharging of the power storage device and is used in a vehicle that includes a power storage device and a charging and discharging device that can charge the power storage device with electricity from the power grid and discharge the power storage device to the power grid. The charging and discharging management system is based on a first deterioration amount that is the deterioration amount of the power storage device when the power storage device is managed in the first state, and a second deterioration amount that is the actual deterioration amount of the power storage device. Adjustment control is performed to control the charging and discharging device so that the power storage device charges and discharges in order to adjust the supply and demand balance of the electric power grid.

### CROSS-REFERENCE TO RELATED APPLICATION

This application claims priority to Japanese Patent Application No. 2023-065805 filed on Apr. 13, 2023, incorporated herein by reference in its entirety.

### BACKGROUND

### 1. Technical Field

The disclosure relates to a charging and discharging management system, and a vehicle.

### 2. Description of Related Art

Conventionally, as this type of charging and discharging management system, a system for use in a vehicle including a power storage device and a charging and discharging device has been proposed (for example, see Japanese Unexamined Patent Application Publication No. 2019-80403 (JP 2019-80403 A)). The charging and discharging device executes charging of the power storage device with electric power from an electric power grid, and discharging of the power storage device to the electric power grid. In this system, charging and discharging of the power storage device is performed with respect to the electric power grid, in order to adjust a supply and demand balance of the electric power grid. In this system, a user or an owner of the vehicle is notified of the degree of deterioration of the power storage device due to charging and discharging with respect to the electric power grid. This enables the user or the owner of the vehicle to determine whether to permit use of the power storage device for adjusting the supply and demand balance of the electric power grid.

### SUMMARY

However, in the above-described charging and discharging management system, when the user or the owner of the vehicle permits the use of the power storage device for adjustment of the supply and demand balance of the electric power grid, the power storage device will charged and discharged for adjustment of the supply and demand balance of the electric power grid, regardless of the degree of deterioration of the power storage device. The main purpose of a vehicle is to be used for traveling, and accordingly it is undesirable for the power storage device to be deteriorates excessively due to adjustment of the supply and demand balance of the electric power grid. Accordingly, there is demand for enabling the power storage device to perform charging and discharging to adjust the supply and demand balance of the electric power grid, while appropriately adjusting the deterioration of the power storage device.

A main object of the charging and discharging management system and the vehicle according to the disclosure is to enable the power storage device to perform charging and discharging for adjusting the supply and demand balance of the electric power grid while appropriately adjusting deterioration of the power storage device.

The charging and discharging management system and the vehicle according to the disclosure employ the following means to achieve the above main object.

In summary, a charging and discharging management system according to the disclosure is a charging and discharging management system that is used in a vehicle including a power storage device, a charging and discharging device configured to execute charging of the power storage device with electric power from an electric power grid and discharging of the power storage device to the electric power grid, and that manages charging and discharging of the power storage device.

Adjustment control is executed to control the charging and discharging device such that the power storage device performs charging and discharging in order to adjust a supply and demand balance of the electric power grid, based on a first deterioration amount that is a deterioration amount of the power storage device when the power storage device is managed in a first state, and a second deterioration amount that is an actual deterioration amount of the power storage device.

In the charging and discharging management system according to the disclosure, adjustment control is executed to control the charging and discharging device such that the power storage device performs charging and discharging in order to adjust the supply and demand balance of the electric power grid, based on the first deterioration amount that is the deterioration amount of the power storage device when the power storage device is managed in the first state, and the second deterioration amount that is the actual deterioration amount of the power storage device. The adjustment control is executed based on the first deterioration amount and the second deterioration amount, and accordingly charging and discharging of the power storage device to adjust the supply and demand balance of the electric power grid can be performed while appropriately adjusting the deterioration of the power storage device.

In such a charging and discharging management system according to the disclosure, the adjustment control may be executed when a deterioration suppression amount, obtained by subtracting a first maintenance rate that is a capacity maintenance rate of the power storage device calculated from the first deterioration amount from a second maintenance rate that is the capacity maintenance rate calculated from the second deterioration amount, exceeds a threshold value during execution of deterioration suppression control in which the charging and discharging device is controlled such that the power storage device is placed in a second state in which deterioration of the power storage device is suppressed as compared to the first state. Thus, by managing the power storage device in the second state, only deterioration by a deterioration amount that is suppressed as compared to when managing the power storage device in the first state is allowed in the adjustment control, and accordingly charging and discharging of the power storage device can be performed to adjust the supply and demand balance of the electric power grid, while suppressing excessive deterioration of the power storage device.

Further, in the charging and discharging management system according to the disclosure, when the deterioration suppression amount exceeds the threshold value during execution of the deterioration suppression control, the adjustment control may be executed at a predetermined timing set in advance as a timing for executing the adjustment control. Thus, adjustment control can be executed at appropriate timing. Here, an example of the “predetermined timing” may include a time at which demand on the electric power grid is increasing, or the like.

Further, in the charging and discharging management system according to the disclosure, even when the deterioration suppression amount becomes no greater than the threshold value during execution of the adjustment control, the adjustment control may be continued until the second maintenance rate becomes no greater than the first maintenance rate. Thus, adjustment control can be continued until the capacity maintenance rate of the power storage device becomes no greater than the first maintenance rate.

In this case, when the deterioration suppression amount becomes no greater than the threshold value and the second maintenance rate becomes no greater than the first maintenance rate during execution of the adjustment control, the adjustment control may be cancelled, and the deterioration suppression control may be executed. Thus, the capacity maintenance rate of the power storage device can be suppressed from becoming no greater than the first maintenance rate.

In the charging and discharging management system according to the disclosure, the first state may be a fully charged state, and the second state may be a state in which a state of charge of the power storage device is smaller than that of the fully charged state.

In summary, a vehicle according to the disclosure is a vehicle including a power storage device, a charging and discharging device configured to execute charging of the power storage device with electric power from an electric power grid and discharging of the power storage device to the electric power grid, and a control device that controls the charging and discharging device.

Adjustment control is executed to control the charging and discharging device such that the power storage device performs charging and discharging in order to adjust a supply and demand balance of the electric power grid, based on a first deterioration amount that is a deterioration amount of the power storage device when the power storage device is managed in a first state, and a second deterioration amount that is an actual deterioration amount of the power storage device.

In the vehicle according to the disclosure, adjustment control is executed to control the charging and discharging device such that the power storage device performs charging and discharging in order to adjust the supply and demand balance of the electric power grid, based on the first deterioration amount that is the deterioration amount of the power storage device when the power storage device is managed in the first state, and the second deterioration amount that is the actual deterioration amount of the power storage device. The adjustment control is executed based on the first deterioration amount and the second deterioration amount, and accordingly charging and discharging of the power storage device to adjust the supply and demand balance of the electric power grid can be performed while appropriately adjusting the deterioration of the power storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically showing the structure of an electric power system 10 incorporating a charging and discharging management system as an embodiment of the present disclosure;

FIG. 2 is a configuration diagram showing an outline of the configuration of the battery electric vehicle 20;

FIG. 3 is a flowchart showing an example of a processing routine executed by the CPU of the vehicle management device 92;

FIG. 4 is an explanatory diagram showing an example of an index setting map; and

FIG. 5 is a timing chart showing an example of a change in the capacity maintenance rate over time after the vehicle-side connector 51 and the system-side connector are connected in the parked battery electric vehicle 20.

### DETAILED DESCRIPTION OF EMBODIMENTS

Next, a mode for carrying out the present disclosure will be described with reference to an embodiment.

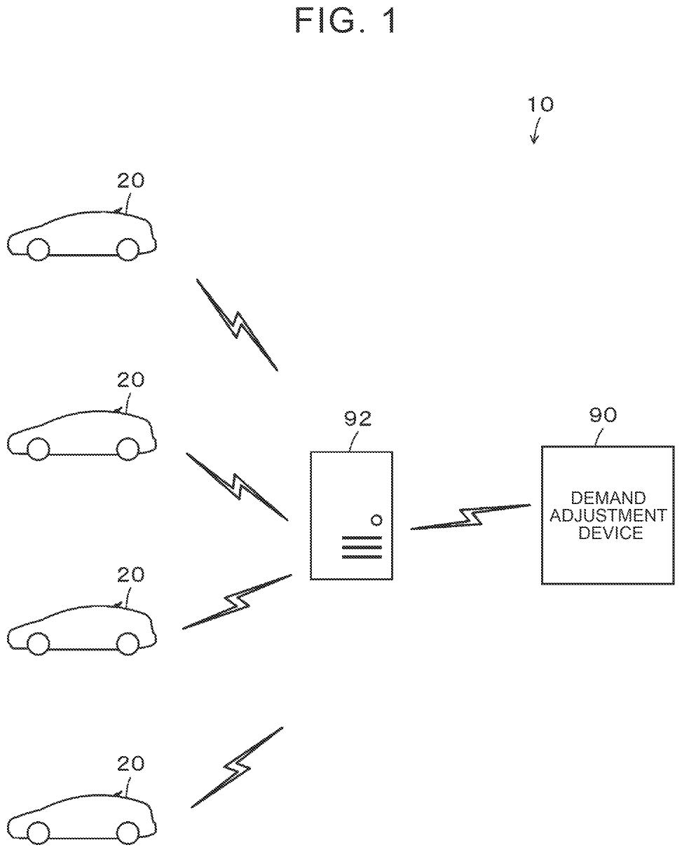

FIG. 1 is a block diagram schematically showing the structure of an electric power system 10 incorporating a charging and discharging management system as an embodiment of the present disclosure. The electric power system 10 is configured as a virtual power plant (VPP) that generates power to be transmitted to the electric power grid that supplies power to individual homes, factories, etc., and includes a plurality of battery electric vehicles 20 and a supply and demand adjustment device. 90 and a vehicle management device 92.

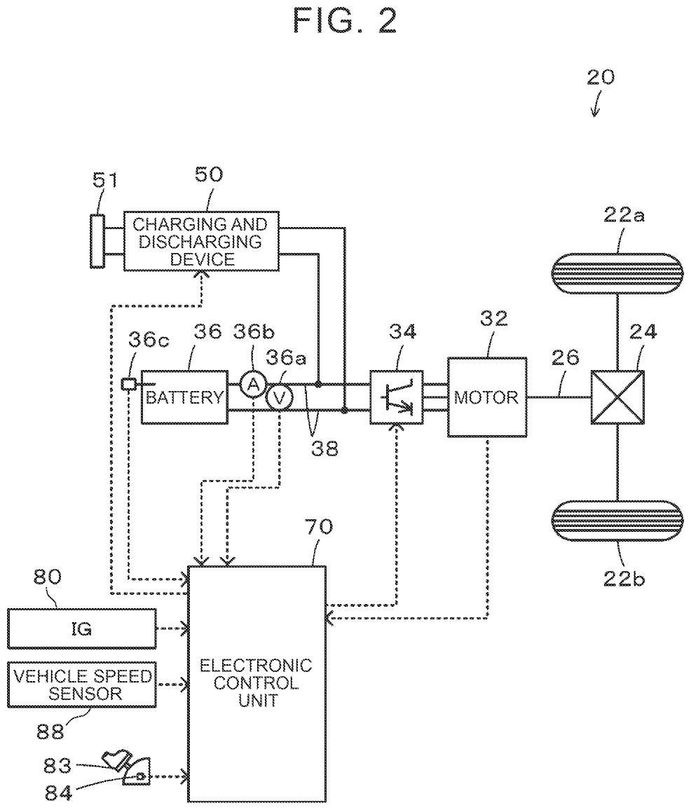

FIG. 2 is a configuration diagram showing an outline of the configuration of the battery electric vehicle 20. As illustrated, each battery electric vehicle 20 includes a motor 32, an inverter 34, a battery 36 as a power storage device, a charging and discharging device 50, and an electronic control unit (control device) 70.

The motor 32 has a rotor connected to a drive shaft 26 that is connected to the drive wheels 22a, 22b via a differential gear 24. The inverter 34 is used to drive the motor 32 and is connected to a battery 36 via an electric power line 38. The motor 32 is rotationally driven by the electronic control unit 70 controlling the switching of a plurality of switching elements (not shown) of the inverter 34. The battery 36 is configured as, for example, a lithium ion secondary battery or a nickel hydride secondary battery.

The charging and discharging device 50 is connected to the electric power line 38, and when the system-side connector connected to the electric power grid and the vehicle-side connector 51 are connected, the charging and discharging device 50 can charge the battery 36 with power from the electric power grid and can discharge the battery 36 with power to the electric power grid. This charging and discharging device 50 is controlled by an electronic control unit 70.

The electronic control unit 70 is configured as a microprocessor centered on a CPU (not shown), and in addition to the CPU, includes a ROM for storing processing programs, a RAM for temporarily storing data, an input/output port, and a communication port. Be prepared. Signals from various sensors are input to the electronic control unit 70 via input ports. The signals input to the electronic control unit 70 include, for example, the rotational position Om of the rotor of the motor 32 from a rotational position sensor (not shown) that detects the rotational position of the rotor of the motor 32, and the phase of each phase of the motor 32. Phase currents Iu, Iv, and Iw of each phase of the motor 32 can be cited from a current sensor (not shown) that detects current. In addition, the voltage Vb of the battery 36 from the voltage sensor 36a attached between the terminals of the battery 36, the input/output current Ib of the battery 36 from the current sensor 36b attached to the output terminal of the battery 36, and the temperature Tb of the battery 36 from the temperature sensor 36c attached to the battery 36 can also be mentioned. The ignition signal from the ignition switch 80, the accelerator operation amount Acc from the accelerator pedal position sensor 84 that detects the amount of depression of the accelerator pedal 83, and the vehicle speed V from the vehicle speed sensor 88 can also be cited. Various control signals are output from the electronic control unit 70 via the output port. Examples of the signals output from the electronic control unit 70 include a control signal to the inverter 34 and a control signal to the charging and discharging device 50. The electronic control unit 70 calculates the power storage ratio SOC of the battery 36 based on the integrated value of the input/output current Ib of the battery 36 from the current sensor 36b. Here, the power storage ratio SOC is the ratio of the capacity stored in the battery 36 to the total capacity of the battery 36. The electronic control unit 70 is configured to be able to communicate wirelessly with the vehicle management device 92.

In the battery electric vehicle 20 configured in this manner, the electronic control unit 70 sets the required torque Td* to the torque command Tm*, and performs switching control of the plurality of switching elements of the inverter 34 so that the motor 32 is driven by the torque command Tm*.

Furthermore, in the battery electric vehicle 20, when the vehicle-side connector 51 and the grid-side connector are connected while the vehicle is parked, the electronic control unit 70 controls the charging and discharging device 50 so that charging and discharging of the battery 36 is performed between the electric power grid to charge and discharge the battery 36.

The supply and demand adjustment device 90 is configured as a microprocessor centered on a CPU (not shown), and in addition to the CPU, it also includes a ROM for storing processing programs, a RAM for temporarily storing data, an input/output port, and a communication port. Be prepared. The supply and demand adjustment device 90 is installed at a power transmission and distribution company (not shown) that is responsible for adjusting supply and demand for the electric power grid. The supply and demand adjustment device 90 exchanges various information with the vehicle management device 92 via communication.

The vehicle management device 92 is configured as a microprocessor centered on a CPU (not shown), and in addition to the CPU, it also includes a ROM for storing processing programs, a RAM for temporarily storing data, an input/output port, and a communication port. Be prepared. The vehicle management device 92 communicates with the plurality of battery electric vehicles 20 and the supply and demand adjustment device 90 to exchange various information. Various information is input to the vehicle management device 92 from the plurality of battery electric vehicles 20 and the supply and demand adjustment device 90 via the communication port. Examples of information input from the plurality of battery electric vehicles 20 include the power storage ratio SOC of the battery 36 mounted in each battery electric vehicle 20 and the connection state between the vehicle-side connector 51 and the system-side connector. The information inputted from the supply and demand adjustment device 90 includes the total required charge as the total amount of charging and discharging electric power required for the batteries 36 of the plurality of battery electric vehicles 20 when the plurality of battery electric vehicles 20 are regarded as one energy resource. Examples include the charging and discharging amount Ctreq. The vehicle management device 92 outputs various information to the plurality of battery electric vehicles 20 and the supply and demand adjustment device 90 via the communication port. The information output to the plurality of battery electric vehicles 20 may include charging and discharging instructions. The information output to the supply and demand adjustment device 90 may include the total amount of electric power that can be charged and discharged by the batteries 36 of all the battery electric vehicles 20.

In the electric power system 10 in which the charging and discharging management system of the embodiment configured in this manner is incorporated, the supply and demand adjustment device 90 determines whether the power supply in the electric power grid is adjusted based on the power demand for the electric power grid and the power that can be supplied from each facility to the electric power grid. A charging and discharging instruction for adjusting the supply and demand balance is transmitted to the vehicle management device 92. The vehicle management device 92 that has received the charging and discharging instruction causes charging and discharging of the battery 36 to be performed in each battery electric vehicle 20 that is parked and has the vehicle side connector 51 connected to the system side connector and can participate in VPP. A charging and discharging request is sent to each battery electric vehicle 20. The electronic control unit 70 of the battery electric vehicle 20 that has received the charging and discharging request executes supply and demand adjustment control to control the charging and discharging device 50 so that charging and discharging of the battery 36 is performed, and participates in the VPP. The vehicle management device 92 executes a remuneration payment procedure for the battery electric vehicle 20 participating in the VPP based on preset remuneration information for each time period and the amount of charged and discharged electric power.

The vehicle management device 92 sets the next scheduled departure time tstart and the required ratio SOCstart as the power storage ratio SOC of the battery 36 necessary for driving based on the current location and travel history of each battery electric vehicle 20, and transmits a driving charging instruction and the required ratio SOCstart to the battery electric vehicle 20 a predetermined time before the scheduled departure time tstart so that the power storage ratio SOC of the battery 36 becomes the required ratio SOCstart at the scheduled departure time tstart. The electronic control unit 70 of the battery electric vehicle 20 that has received the driving charging instruction and the required ratio SOCstart controls the charging and discharging device 50 so that the power storage ratio SOC of the battery 36 becomes the required ratio SOCstart without participating in VPP. do.

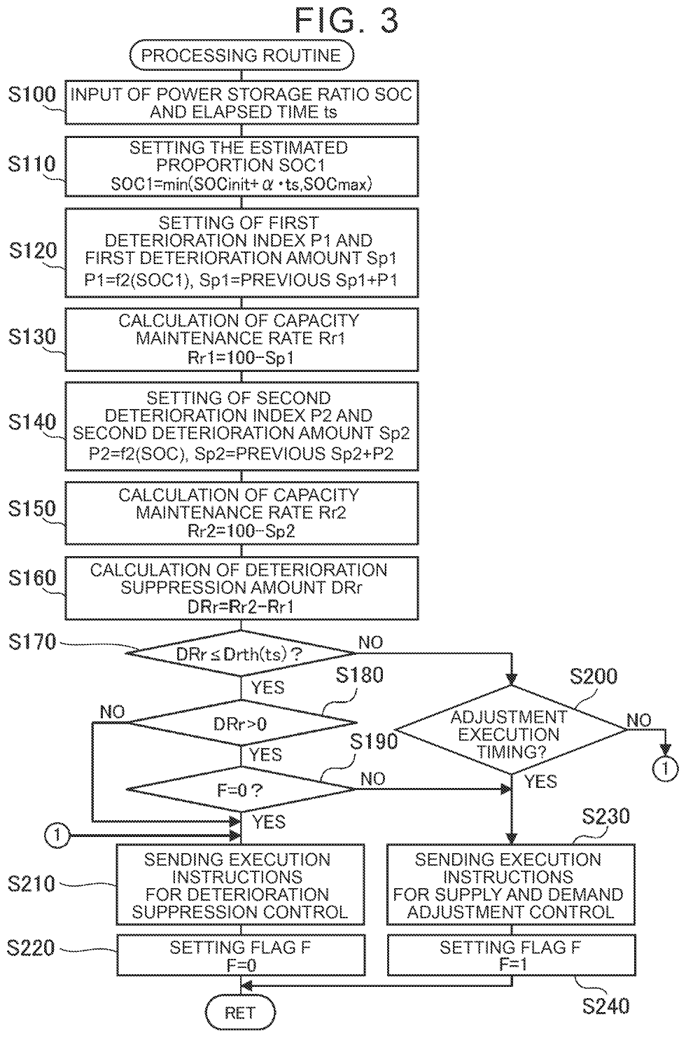

Next, we will discuss the operation of the electric power system 10 incorporating the charging and discharging management system of the embodiment configured as described above, in particular, the operation of the battery 36 installed in the battery electric vehicle 20 to which the vehicle side connector 51 and the grid side connector are connected. The operation during charging and discharging will be explained. FIG. 3 is a flowchart showing an example of a processing routine executed by the CPU of the vehicle management device 92. This routine is repeatedly executed at predetermined time intervals (for example, every few seconds) when the vehicle management device 92 receives a charging and discharging request from the supply and demand adjustment device 90.

When this routine is executed, the CPU of the vehicle management device 92 executes a process of inputting the power storage ratio SOC and the elapsed time ts (S100). The power storage ratio SOC is calculated by the electronic control unit 70 of the battery electric vehicle 20 and is input via communication. The elapsed time ts is the elapsed time since the vehicle-side connector 51 and the system-side connector were connected, and the time measured by the electronic control unit 70 of the battery electric vehicle 20 is input.

Subsequently, the estimated ratio SOC1 is set using the following equation (1) using the elapsed time ts (S110). In formula (1), “α” is a value predetermined as the time increase rate of the power storage ratio SOC when charging the battery 36 with electric power from the electric power grid. “SOCinit” is the power storage ratio SOC when the vehicle side connector 51 and the system side connector are connected. “SOCmax” is the power storage ratio SOC when the battery 36 is fully charged, and is set to, for example, 90%, 95%, 100%, etc. The estimated ratio SOC1 increases at a time increase rate a from when the vehicle side connector 51 and the system side connector are connected until it reaches the maximum ratio SOCmax, and after reaching the maximum ratio SOCmax, it is maintained at the maximum ratio SOCmax regardless of the elapsed time ts. is set to be That is, the estimated ratio SOC1 is set to be the power storage ratio SOC when the charging and discharging device 50 is controlled so that the battery 36 has the maximum ratio SOCmax (when the battery 36 is managed to be fully charged).

$$S O C 1 = min ( α \cdot ts + S O C init , S O C max ) \qquad ( 1 )$$

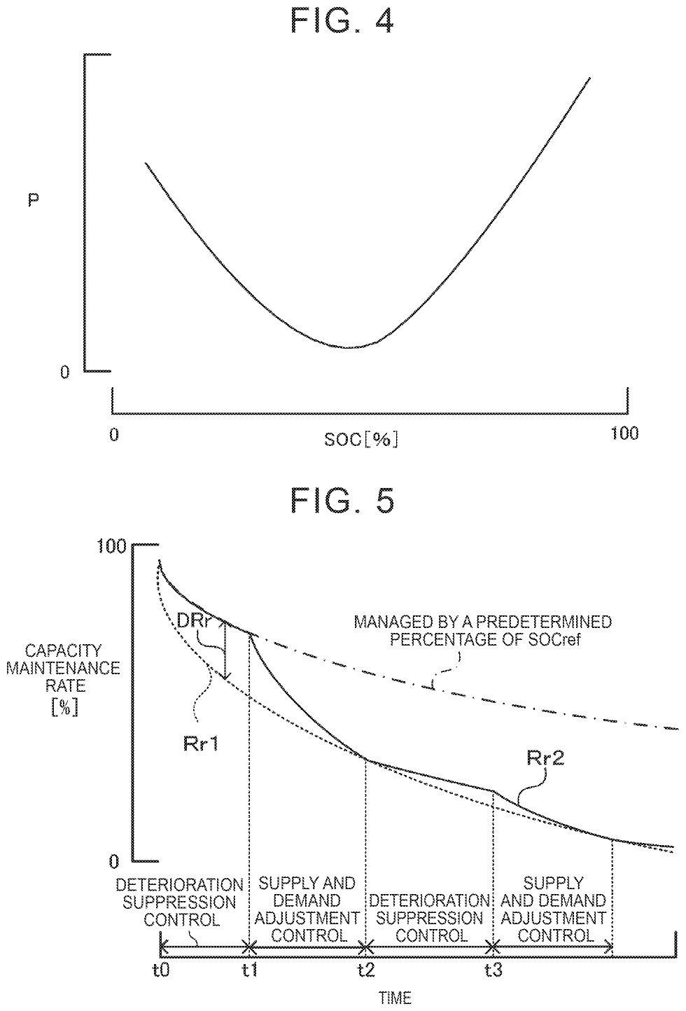

After setting the estimated ratio SOC1, the CPU of the vehicle management device 92 uses the estimated ratio SOC1 to set the first deterioration index P1 and the first deterioration amount (S120). The first deterioration index P1 is the deterioration amount of the battery 36 per unit time when the battery 36 is managed with a full charge (the amount of decrease in the discharge capacity of the battery 36 per unit time expressed as a percentage). The first deterioration index P1 is set by storing the relationship between the power storage ratio SOC and the deterioration index P in advance as an index setting map, and deriving the corresponding deterioration index P from the index setting map when the power storage ratio SOC is set to the estimated ratio SOC1. FIG. 4 is an explanatory diagram showing an example of an index setting map. The index setting map is set for each battery electric vehicle 20 based on the specifications of the battery 36 and the like. The first deterioration amount Sp1 is an integrated value of the first deterioration index P1 after the vehicle-side connector 51 and the system-side connector are connected. The first deterioration amount Sp1 is set by adding the first deterioration index P1 set this time to the first deterioration amount Sp1 when this routine was executed last time (previous Sp1) using the following equation (2).

$$Sp 1 = Previous Sp 1 + P 1 \qquad ( 2 )$$

After setting the first deterioration amount Sp1 in this way, the first deterioration amount Sp1 is subtracted from the value 100 to set the capacity maintenance rate (first maintenance rate) Rr1 when the battery 36 is managed with a full charge (S130).

Next, a second deterioration index P2 and a second deterioration amount Sp2 are set based on the power storage ratio SOC input in S100 (S140). The second deterioration index P2 is the deterioration amount of the battery 36 per unit time at the current power storage ratio SOC. The second deterioration index P2 is set by the map used when setting the first deterioration index P1. The second deterioration amount Sp2 is an integrated value of the second deterioration index P2 after the vehicle-side connector 51 and the system-side connector are connected. The second deterioration amount Sp2 is set by adding the second deterioration index P2 set this time to the second deterioration amount Sp2 when this routine was executed last time (previous Sp2) using the following equation (3).

$$Sp 2 = previous Sp 2 + P 2 \qquad ( 3 )$$

After setting the second deterioration amount Sp2 in this way, the second deterioration amount Sp2 is subtracted from the value 100 to set the current capacity maintenance rate (second maintenance rate) Rr2 (S150).

After setting the capacity maintenance rates Rr1 and Rr2 in this way, the deterioration suppression amount DRr is calculated by subtracting the capacity maintenance rate Rr1 from the capacity maintenance rate Rr2 (S160), and it is determined whether the deterioration suppression amount DRr is equal to or less than the threshold value Drth that is set using the clapsed time ts (S170). The threshold value Drth is a threshold value for determining whether the capacity maintenance rate of the battery 36 has a sufficient margin with respect to the capacity maintenance rate when the battery 36 is assumed to be fully charged. The threshold Drth is set within a range greater than 0 so that when the elapsed time ts is long, it is smaller than when it is short. The reason why the threshold value Drth is thus set according to the elapsed time ts will be described later.

When the deterioration suppression amount DRr is equal to or less than the threshold value Drth in S170, it is determined whether the deterioration suppression amount DRr is larger than the value 0 (S180). When the deterioration suppression amount DRr is less than or equal to the value 0, an instruction to execute the deterioration suppression control is transmitted to the battery electric vehicle 20 (S210), the value 0 is set to the flag F (S220), and this routine is ended. The electronic control unit 70 of the battery electric vehicle that has received the execution instruction for deterioration suppression control executes deterioration suppression control for controlling the charging and discharging device 50 so that the power storage ratio SOC of the battery 36 becomes a predetermined rate SOCref at which deterioration of the battery 36 is suppressed, without participating in the VPP. The predetermined ratio SOCref is a storage ratio that is predetermined based on the characteristics of the battery 36 as a storage ratio that causes less deterioration of the battery 36. For example, the predetermined ratio SOCref is set to be smaller than the maximum ratio SOCmax, such as 45%, 50%, 55%, etc. Ru. Through the deterioration suppression control, the battery 36 is managed so that the power storage ratio SOC becomes a predetermined rate SOCref.

When the deterioration suppression amount DRr exceeds the value 0 in S210, it is determined whether the flag F is the value 0 (S190), and when the flag F is the value 0, an instruction to execute the deterioration suppression control is given to the battery electric vehicle 20. It is transmitted (S210), the value 0 is set to flag F (S220), and this routine ends.

When the deterioration suppression amount DRr exceeds the threshold value Drth in S170, it is determined whether it is the adjustment execution timing (predetermined timing) at which supply and demand adjustment control should be executed (S200). In S200, the adjustment is executed at predetermined high reward timings, such as timings when the demand on the electric power grid increases, such as during the daytime in summer or at night in winter, when the reward for the battery electric vehicle 20 participating in the VPP is high. It is determined that the timing is right. Furthermore, when it is not the high reward timing, it is determined that it is not the adjustment execution timing.

When it is determined in S200 that it is not the adjustment execution timing, an instruction to execute deterioration suppression control is sent to the battery electric vehicle 20 (S210), a value of 0 is set to flag F (S220), and this routine is ended. When it is the adjustment execution timing in S200, an instruction to execute the supply and demand adjustment control is transmitted to the battery electric vehicle 20 (S230), the flag F is set to the value 1 (S240), and this routine is ended. The electronic control unit 70 of the battery electric vehicle 20 that has received the instruction to execute the supply and demand adjustment control executes the supply and demand adjustment control and participates in the VPP.

When the deterioration suppression amount DRr is equal to or less than the threshold value Drth in S170, the deterioration suppression amount DRr is greater than the value 0 in S180, and the flag F is the value 1 in S190, an instruction to execute supply and demand adjustment control is sent to the battery electric vehicle 20 (S230), sets the value 1 to flag F (S240), and ends this routine. The electronic control unit 70 of the battery electric vehicle 20 that has received the instruction to execute the supply and demand adjustment control executes the supply and demand adjustment control and participates in the VPP.

FIG. 5 is a timing chart showing an example of a change in the capacity maintenance rate over time after the vehicle-side connector 51 and the system-side connector are connected in the parked battery electric vehicle 20. In the figure, a solid line indicates an example of a change in the capacity maintenance rate Rr2 over time. A broken line indicates an example of a change in the capacity maintenance rate Rr1 over time. The one-dot chain line shows an example of a time change in the capacity maintenance rate when the battery 36 is continuously managed at a predetermined ratio SOCref after the vehicle-side connector 51 and the system-side connector are connected.

When the vehicle-side connector 51 and the grid-side connector are connected (time t0), the estimated ratio SOC1 is the same value as the power storage ratio SOC, so the capacity maintenance rate Rr1 and the capacity maintenance rate Rr2 are set to the same value. (S110 to S150), the deterioration suppression amount DRr becomes 0 (S160), an instruction to execute deterioration suppression control is sent to the battery electric vehicle 20, and the flag F is set to 0 (S170, S180, S210, S220)). The battery electric vehicle that has received the instruction to execute the deterioration suppression control executes the deterioration suppression control. The deterioration suppression control is continued until the deterioration suppression amount DRr exceeds the threshold Drth in S170 (times to to t1).

When the deterioration suppression amount DRr exceeds the threshold Drth in S170 (time t1), at the adjustment execution timing, an instruction to execute supply and demand adjustment control is transmitted to the battery electric vehicle 20, and the battery electric vehicle 20 executes the supply and demand adjustment control; Flag F is set to the value 1 (S230, S240). When the supply and demand adjustment control is executed in the battery electric vehicle 20, the deterioration suppression amount DRr falls below the threshold Drth, but since the flag F is I until the deterioration suppression amount DRr becomes 0 or less, the supply and demand adjustment control is continued. (times t1 to t2, S180, S190, S230, S240).

When the deterioration suppression amount DRr becomes equal to or less than the value 0 in S180 (time t2), an instruction to execute the deterioration suppression control is transmitted to the battery electric vehicle 20, and the flag F is set to the value 0 (S170, S180, S210, S220). The battery electric vehicle 20 that has received the instruction to execute the deterioration suppression control executes the deterioration suppression control. Then, the supply and demand adjustment control is continued until the deterioration suppression amount DRr exceeds the threshold Drth (times t2 to t3). Through such control, the supply and demand adjustment control and the deterioration suppression control are repeatedly performed while suppressing the capacity maintenance rate Rr2 from falling below the capacity maintenance rate Rr1 when the battery 36 is maintained at full charge. Thereby, charging and discharging of the battery 36 can be performed to adjust the supply and demand balance of the electric power grid while appropriately adjusting deterioration of the battery 36. In S170, if the threshold Drth is set to a constant value regardless of the elapsed time ts, a relatively long time is required for the deterioration suppression amount DRr to reach the threshold Drth even if execution of the deterioration suppression control is started at time t2, for example. Therefore, opportunities to execute supply and demand adjustment control are reduced. In the embodiment, since the threshold value Drth is set smaller when the elapsed time t is long than when it is short, the time from when the deterioration suppression amount DRr reaches the threshold value Drth after starting execution of the deterioration suppression control is relatively short. be able to. Thereby, it is possible to suppress a decrease in opportunities to execute supply and demand adjustment control.

According to the electric power system 10 incorporating the charging and discharging management system of the embodiment described above, by executing supply and demand adjustment control that controls the charging and discharging device 50 so that the battery 36 is charged and discharged to adjust the supply and demand balance of the electric power grid, based on the first deterioration amount Sp1, which is the deterioration amount of the battery 36 when the battery 36 is managed at full charge, and the second deterioration amount Sp2, which is the actual deterioration amount of the battery 36, the battery 36 can be charged and discharged to adjust the supply and demand balance of the electric power grid while appropriately adjusting the deterioration of the battery 36.

Further, during execution of the deterioration suppression control that controls the charging and discharging device 50 so that the power storage ratio SOC at which deterioration of the battery 36 is suppressed from being fully charged becomes a predetermined rate SOCref, the battery 36 is calculated from the first deterioration amount Sp1. When the deterioration suppression amount DRr, which is obtained by subtracting the capacity maintenance rate (first maintenance rate) Rr1 from the capacity maintenance rate (second maintenance rate) Rr2 calculated from the second deterioration amount Sp2, exceeds the threshold Drth, supply and demand adjustment control is performed. By executing the above, it is possible to charge and discharge the battery 36 for adjusting the supply and demand balance of the electric power grid while suppressing excessive deterioration of the battery 36.

Furthermore, when the deterioration suppression amount DRr exceeds the threshold value DRrref during execution of the deterioration suppression control, by executing the adjustment control at the adjustment execution timing, the adjustment control can be executed at an appropriate timing.

In the electric power system 10 in which the charging and discharging management system of the embodiment is incorporated, the deterioration suppression amount DRr is determined by subtracting the capacity maintenance rate Rr1 from the capacity maintenance rate Rr2, and it is determined whether the deterioration suppression amount DRr is less than or equal to the threshold value Drth. However, since it is sufficient to execute the supply and demand adjustment control based on the first deterioration amount Sp1 and the second deterioration amount Sp2, the deterioration suppression amount Dsp1, which is obtained by subtracting the second deterioration amount Sp2 from the first deterioration amount Sp1, is equal to or less than the threshold value Dsplref. It is also possible to determine whether there is, and to transmit an instruction to execute the supply and demand adjustment control to the battery electric vehicle 20 when the deterioration suppression amount Dsp1 exceeds the threshold value Dsplref and it is the adjustment execution timing.

In the electric power system 10 incorporating the charging and discharging management system of the embodiment, when the deterioration suppression amount DRr exceeds the threshold value Drth, an instruction to execute supply and demand adjustment control is transmitted to the battery electric vehicle 20 at the adjustment execution timing. However, an instruction to execute the supply and demand adjustment control may be transmitted to the battery electric vehicle 20 when the deterioration suppression amount DRr exceeds the threshold Drth, without considering whether it is the adjustment execution timing.

In the electric power system 10 incorporating the charging and discharging management system of the embodiment, the threshold value Drth is set to be smaller when the elapsed time ts is long than when it is short. However, the threshold Drth may be set to a constant value regardless of the elapsed time ts.

In the electric power system 10 incorporating the charging and discharging management system of the embodiment, the vehicle management device 92 executes the processing routine illustrated in FIG. 3. However, part or all of the processing routine illustrated in FIG. 3 may be executed by the electronic control unit 70 of the battery electric vehicle 20.

The correspondence between the main elements of the embodiment and the main elements of the disclosure described in SUMMARY will be described. In the embodiment, the vehicle management device 92 and the electronic control unit 70 of the battery electric vehicle 20 correspond to a “charging and discharging management system.”

As for the correspondence between the main elements of the embodiment and the main elements of the disclosure described in SUMMARY, since the embodiment is an example for specifically describing a mode for carrying out the disclosure described in SUMMARY, the embodiment does not limit the elements of the disclosure described in SUMMARY. In other words, the interpretation of the disclosure described in SUMMARY should be performed based on the description in SUMMARY, and the embodiment is merely a specific example of the disclosure described in SUMMARY.

Although a mode for carrying out the present disclosure has been described above with reference to the embodiment, the present disclosure is not limited to the embodiment, and it goes without saying that the present disclosure can be carried out in various modes without departing from the gist of the present disclosure.

This disclosure can be utilized for a charging and discharging management system.

What is claimed is:

1. A charging and discharging management system that is used in a vehicle including a power storage device, a charging and discharging device configured to execute charging of the power storage device with electric power from an electric power grid and discharging of the power storage device to the electric power grid, and that manages charging and discharging of the power storage device, wherein adjustment control is executed to control the charging and discharging device such that the power storage device performs charging and discharging in order to adjust a supply and demand balance of the electric power grid, based on a first deterioration amount that is a deterioration amount of the power storage device when the power storage device is managed in a first state, and a second deterioration amount that is an actual deterioration amount of the power storage device.

2. The charging and discharging management system according to claim 1, wherein the adjustment control is executed when a deterioration suppression amount, obtained by subtracting a first maintenance rate that is a capacity maintenance rate of the power storage device calculated from the first deterioration amount from a second maintenance rate that is the capacity maintenance rate calculated from the second deterioration amount, exceeds a threshold value during execution of deterioration suppression control in which the charging and discharging device is controlled such that the power storage device is placed in a second state in which deterioration of the power storage device is suppressed as compared to the first state.

3. The charging and discharging management system according to claim 2, wherein when the deterioration suppression amount exceeds the threshold value during execution of the deterioration suppression control, the adjustment control is executed at a predetermined timing set in advance as a timing for executing the adjustment control.

4. The charging and discharging management system according to claim 2, wherein, even when the deterioration suppression amount becomes no greater than the threshold value during execution of the adjustment control, the adjustment control is continued until the second maintenance rate becomes no greater than the first maintenance rate.

5. A vehicle, comprising: a power storage device; a charging and discharging device configured to execute charging of the power storage device with electric power from an electric power grid and discharging of the power storage device to the electric power grid; and a control device that controls the charging and discharging device, wherein adjustment control is executed to control the charging and discharging device such that the power storage device performs charging and discharging in order to adjust a supply and demand balance of the electric power grid, based on a first deterioration amount that is a deterioration amount of the power storage device when the power storage device is managed in a first state, and a second deterioration amount that is an actual deterioration amount of the power storage device.
